(19) United States
(12) Patent Application Publication
(10) Pub. No.: US 2011/0119115 A1
(43) Pub. Date: May 19, 2011

(54) System Generated Benchmarks

(75) Inventors: Mingde Xu, San Jose, CA (US); Robert Koch, San Francisco, CA (US)

(73) Assignee: HARA SOFTWARE, INC., Redwood City, CA (US)

(21) Appl. No.: 12/748,084

(22) Filed: Mar. 26, 2010

(51) Int. Cl. G06F 19/00

(52) U.S. Cl. 705/7.39

(57) ABSTRACT

A centralized emission management system is implemented via a server that is accessible to a large number of entities. The entities upload information relevant to determining a measure of environmental impact. The server calculates benchmarks for a performance metric based on the entities' measures of environmental impact and certain normalization factors. Based on a comparison of the performance metric of an entity against one or more benchmarks, the server may transmit initiatives to the entity for reducing environmental impact and an alert to related subordinate entities to reduce their environmental impact.

### FIELD OF INVENTION

This present disclosure is related generally to the field of emissions management, such as greenhouse gas (GHG) emissions management, and more specifically to a centralized emission management system that generated benchmarks.

### DESCRIPTION OF RELATED ART

“Emissions” refer to the introduction of chemicals, particulate matter, or biological materials into the atmosphere, ground, or water system that potentially can cause harm or discomfort to humans or other living organisms, or may damage the natural environment.

GHG is a collective term for gases such as carbon dioxide, methane, HFCs, SF6, and nitrous oxide that trap heat in the atmosphere and contribute to climate change. GHG accounting and reporting is the discipline of tracking GHGs produced as a result of executing business processes, including manufacturing, travel, keeping of livestock, etc.

The term “carbon dioxide equivalent” (CO2e) is a common normalized unit of measurement, such as expressed in tonnes of CO2e, that is used to compare the relative climate impact of the different GHGs. The CO2e quantity of any GHG is the amount of carbon dioxide that would produce the equivalent global warming potential. There are publicly accepted factors that are used to convert an entity's emissions, usage of resources (e.g., electricity, gas, oil, coal, etc.), or waste products, among other things, into a CO2e emission.

A company or other entity may want to, or be required to, reduce their CO2e emissions or energy usage. For example, a company's CO2e emissions may be capped by a governmental or industrial organization within an established time frame. A company may wish to reduce energy consumption simply to save money. Thus what is needed is a tool that helps the company evaluate its performance against others to determine initiatives and strategies to meet the company's target for emissions, energy usage, or other goal.

### SUMMARY

In one or more embodiments of the present disclosure, a centralized emission management system is implemented via a server that is accessible to a large number of entities. The entities upload information relevant to determining a measure of environmental impact. The server calculates benchmarks for a performance metric based on the entities' measures of environmental impact and certain normalization factors. Based on a comparison of the performance metric of an entity against one or more benchmarks, the server may transmit initiatives to the entity for reducing environmental impact and an alert to related subordinate entities to reduce their environmental impact.

### BRIEF DESCRIPTION OF THE DRAWINGS

In the drawings:

FIG. 1 illustrates a web-based emission management system in one or more embodiments of the present disclosure;

FIG. 2 illustrates is a flowchart of a method implemented with algorithms executed by a programmed processor in a server of FIG. 1 to generate benchmarks in one or more embodiments of the present disclosure;

FIG. 3 shows a graphical user interface (GUI) generated by the server of FIG. 1 for a client to select global benchmark types in one or more embodiments of the present disclosure;

FIG. 4 shows a GUI generated by the server of FIG. 1 for the client to add internal benchmark types in one or more embodiments of the present disclosure; and

FIG. 5 shows a GUI generated by the server of FIG. 1 for the client to see the system generated benchmarks in one or more embodiments of the present disclosure.

Use of the same reference numbers in different figures indicates similar or identical elements.

### DETAILED DESCRIPTION OF THE INVENTION

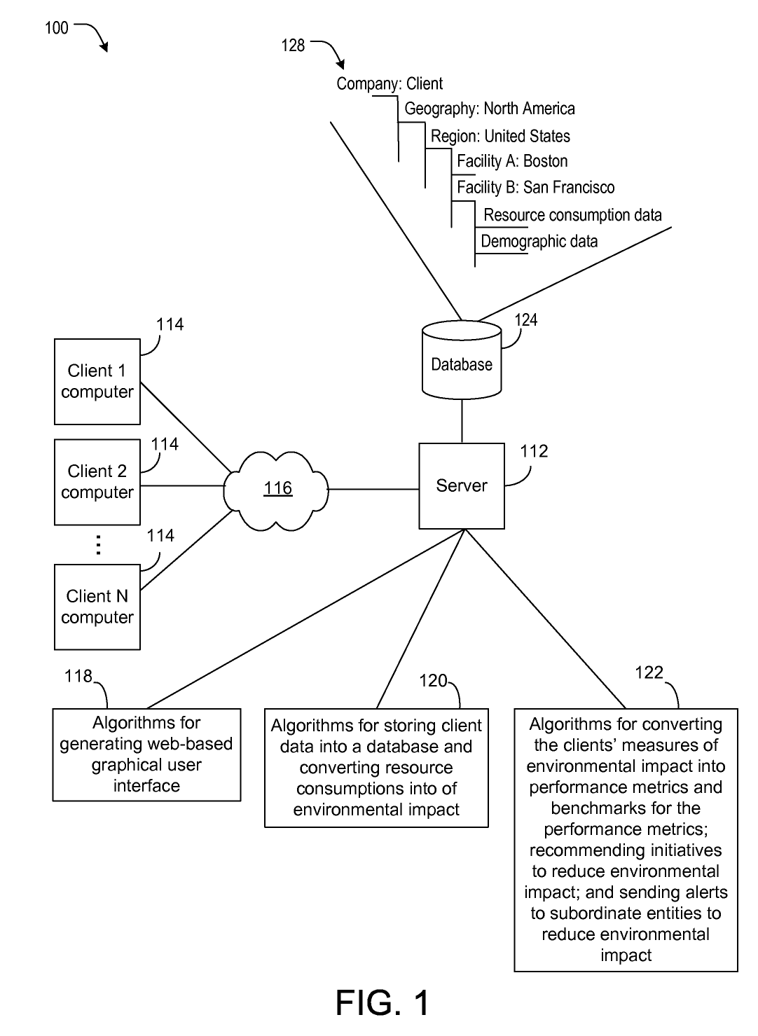

FIG. 1 illustrates a web-based emission management system 100 in one or more embodiments of the present disclosure. A server 112, which may be managed by a host entity, provides a web-based GUI that interacts with the various client entities to allow the clients to upload data to server 112, view information generated by server 112 relating to environmental impact, and allow the clients to interact with the displayed information to develop emission reduction strategies. Server 112 and the clients' computers 114 communicate via a public or private computer network 116, such as the Internet. A client accesses its account using passwords or other methods.

Although server 112 has many functions, and there may be a plurality of servers, only one server and its emission management software related to the present disclosure are illustrated. The emission management software includes algorithms 118, 120, and 122, which are stored along with their data in a non-transitory computer-readable medium. Algorithms 118 are for generating the web-based GUI and related functions. Algorithms 120 are for storing the clients' entered data into a database 124 and converting the clients' resource consumptions and other relevant information into CO2e emissions, wastewater production, or other measures of environmental impact. Algorithms 122 are for converting the clients' measures of environmental impact into performance metrics and benchmarks for those performance metrics; filtering the benchmarks by including only data from clients that meet one or more criteria, recommending initiatives to reduce environmental impact based on a comparison of the performance metrics and the benchmarks; and sending alerts to reduce environmental impact to subordinate entities based on the comparison of the performance metrics and the benchmarks.

A client initially sets up its account in the emission management software by providing a company model 128 with a hierarchy of its organization units via the web-based GUI or an upload of a compatible file with such information. The hierarchical levels of the organization units may include geographical areas such as continents, regions such as countries in a geographical area, and facilities such as cities in a region. The client then inputs information for each organization unit using the web-based GUI or an upload of a compatible file with such information. The emission management software is able to present processed information to the client on a per facility basis or aggregated for different hierarchical levels of the company.

The client provides information for each organizational unit relevant to environmental impact. Some of the information may be related to resource consumption of an organizational unit, such as types of energy used (e.g., electricity, natural gas, diesel, oil, coal, etc.), quantities of energy used (e.g., kwh, gallons, etc.), dates of energy used, costs of energy used, airline travel, lighting usage, types/amounts of products manufactured and types/amounts of emissions, efficiencies, waste products, water usage, raw input product usage (e.g., paper, metals, etc.), costs of various pertinent resources, and other types of data pertinent to resource consumption. Server 112 may save the individual resource consumption entries as resource consumption items for the organizational unit in database 124. Some of the information may be related to demographics of the organizational unit, such as facility area (e.g., square footage), facility revenue, facility produced units, facility type (e.g., office, manufacturing, etc.), facility age, facility operating hours, facility employee count, facility HVAC type, facility location, industry, and other types of data pertinent to demographics.

Each input resource and/or output product, assuming a certain usage efficiency, is applied to an appropriate algorithm to determine its corresponding CO2e emission quantity or other unit of measurement. Many of the algorithms 120 correlating resources, outputs, or activities to an equivalent CO2e emission are based on publicly known standards, such as the Emissions & Generation Resource Integrated Database (eGRID) conversion factors used by the Environmental Protection Agency (EPA).

The raw data, e.g., in terms of natural gas or gallons of gasoline, is periodically input by the clients, such as at the end of each accounting period, which may be yearly. The client's data may also include information that is automatically uploaded to the server 112 through any interface, such as a utility meter for electricity, water, etc. Server 112 stores the past data in database 124. The server 112 processes the data and presents the processed data to the client in a suitable presentation on the web-based GUI, upon the client requesting the presentation.

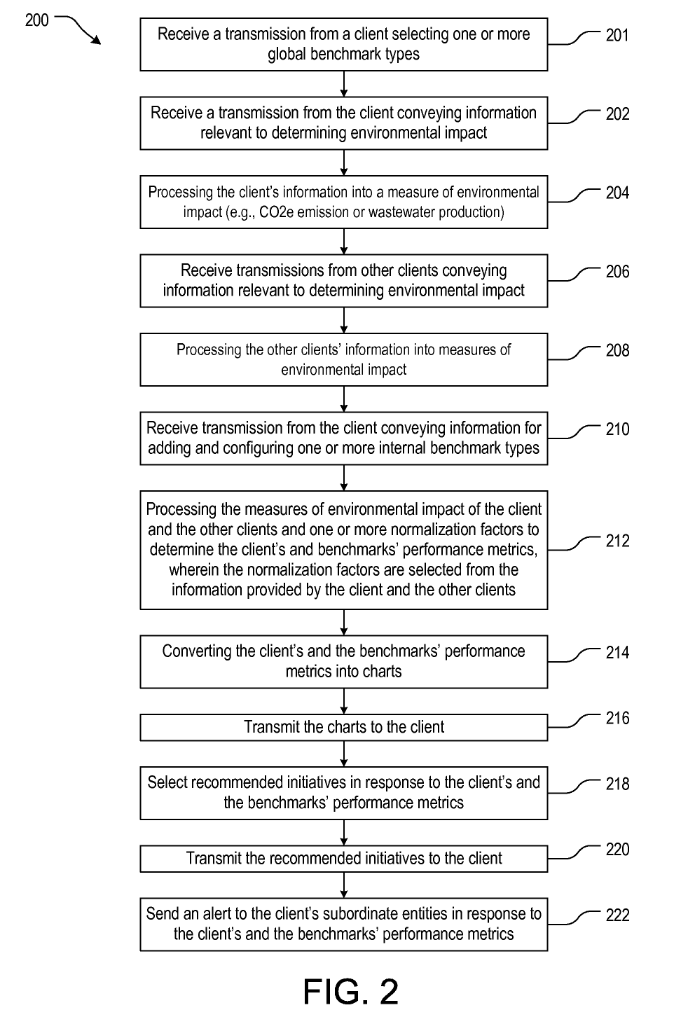

FIG. 2 is a flowchart of a method 200 implemented with algorithms 122 executed by a programmed processor in server 112 to generate benchmarks in one or more embodiments of the present disclosure. Method 200 may comprise one or more operations, functions or actions as illustrated by one or more of blocks. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation.

Method 200 may begin in block 201 as part of the initial setup of a client's account with the emission management software. In block 201, server 112 receives from the client (e.g., client 1 in FIG. 1) a selection of one or more types of global benchmarks to be generated from data across all the clients of the emission management software.

A benchmark type sets the performance metric from which a benchmark is to be generated. A performance metric is a measure of environmental impact divided by a normalization factor, such as CO2e emissions per employee. The normalization factor is selected from demographic data provided by all the clients. For each global benchmark type, predefined benchmarks may be generated based on predefined demographic filters. For example, three benchmarks may be generated from (1) clients that are corporately related, (2) clients that are in the same industry, and (3) clients that are in the same region.

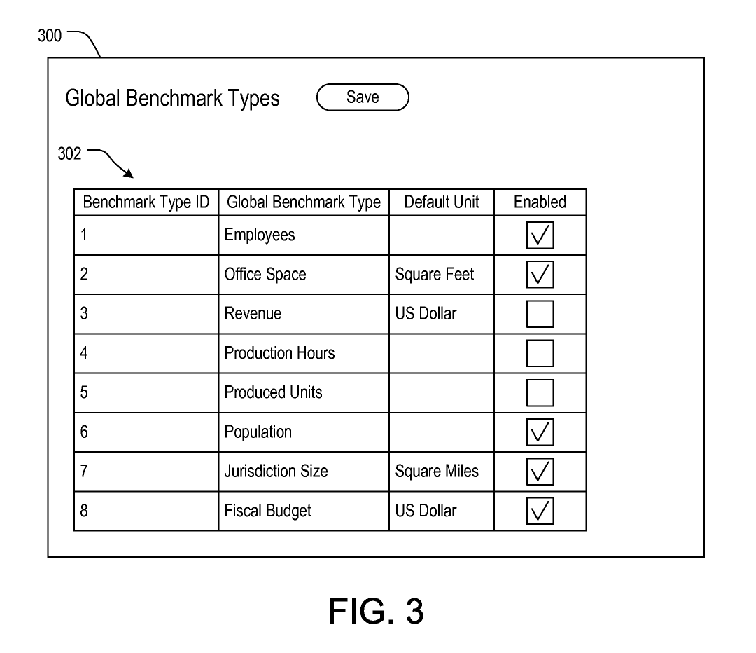

FIG. 3 shows a GUI 300 generated by server 112 for client 1 to submit the selection of one or more global benchmark types in one or more embodiments of the present disclosure. GUI 300 includes a table 302 having a first column with benchmark type IDs, a second column with benchmark type descriptions, a third column with default units for the benchmark types, and a fourth column with check boxes for selecting/enabling the benchmark types. Referring back to FIG. 2, block 201 may be followed by block 202.

In block 202, server 112 receives a transmission of resource consumption data and demographic data from client 1. This data is accumulated over time by server 112. The resource consumption data may be used to calculate measures of environmental impact, and the demographic data may be used as normalization factors for performance metrics as described above. Block 202 may be followed by block 204.

In block 204, server 112 processes client 1's resource consumption data to determine the client's values for the measures of environmental impact, such as CO2e emission, wastewater production, or resource consumption. Typically server 112 determines the measures of environmental impact of organizational units at the facility level and then propagates those values up the higher hierarchical levels. Block 204 may be followed by block 206.

In block 206, server 112 receives a transmission of resource consumption data and demographic data from other clients (e.g., clients 2 to N in FIG. 1). This data is accumulated over time by server 112. The resource consumption data may be used to calculate measures of environmental impact, and the demographic data may be used as normalization factors for performance metrics as described above. Block 206 may be followed by block 208.

In block 208, server 112 processes the clients 2 to N's resource consumption data to determine the other clients' values for the measures of environmental impact. Typically server 112 determines the measures of environmental impact of organizational units at the facility level and then propagates those values up the higher hierarchical levels. Block 208 may be followed by block 210.

In block 210, server 112 receives a transmission from client 1 conveying information for adding one or more types of internal benchmark to be generated from data across organizational units within the client. For each internal benchmark type, the client may add benchmarks based demographic filters.

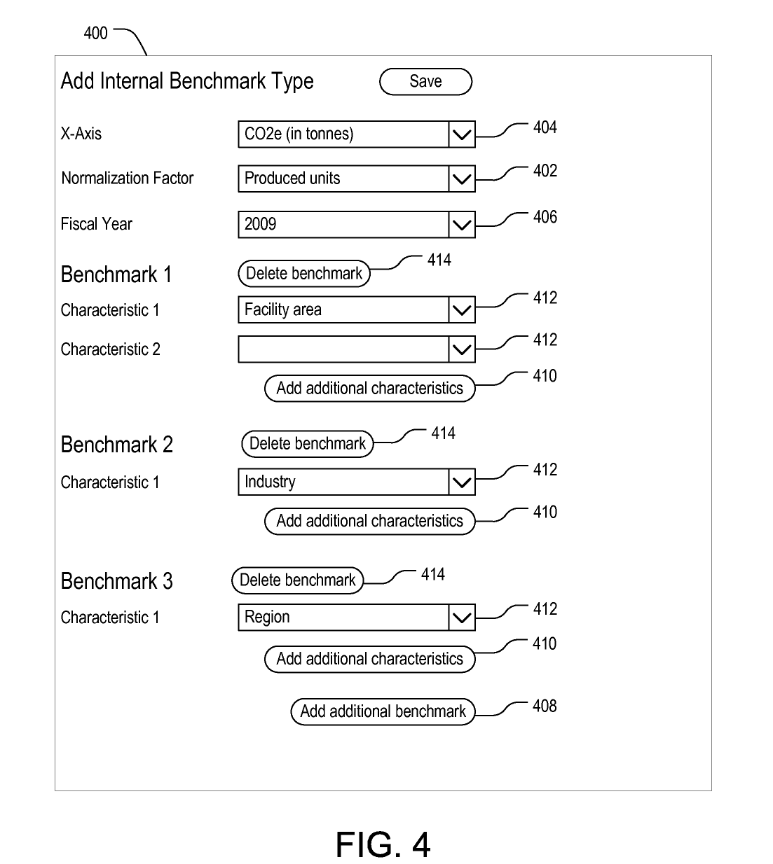

FIG. 4 shows a GUI 400 generated by server 112 for client 1 to convey information for adding an internal benchmark type in one or more embodiments of the present disclosure. Client 1 selects a measure of environmental impact from a menu 404, a normalization factor from a menu 402, and a fiscal year for the data from a menu 406. The normalization factors include the number of employees, area of office space, the revenue, the production hours, the production units, the population, area of the jurisdiction, the fiscal budget, and any demographic data common to the organizational units. The measures of environmental impact include CO2e emission, wastewater production, and resource consumption.

Client 1 adds a benchmark for the selected internal benchmark type using a button 408. The client may add a demographic filter to a benchmark using a button 410. A demographic filter determines a subset of the organizational units of the client that makes up the benchmark. The client selects a demographic filter using menus 412. The subset of the organization units should have similar values for one or more demographic filters as the client or values for the one or more characteristics within a specified range. The client may delete a benchmark using a button 414.

Referring back to FIG. 2, block 210 may be followed by block 212.

In block 212, for a specified organization unit of the client, server 112 processes the client's values for the measures of environmental impact and the normalization factors to determine the performance metrics and the internal benchmarks of client 1. Sever 112 also processes all the clients' values for the measure of environmental impact and the normalization factors to determine the global benchmarks. The values for the normalization factors are gathered from the data provided in blocks 202 and 206. Block 216 may be followed by block 218.

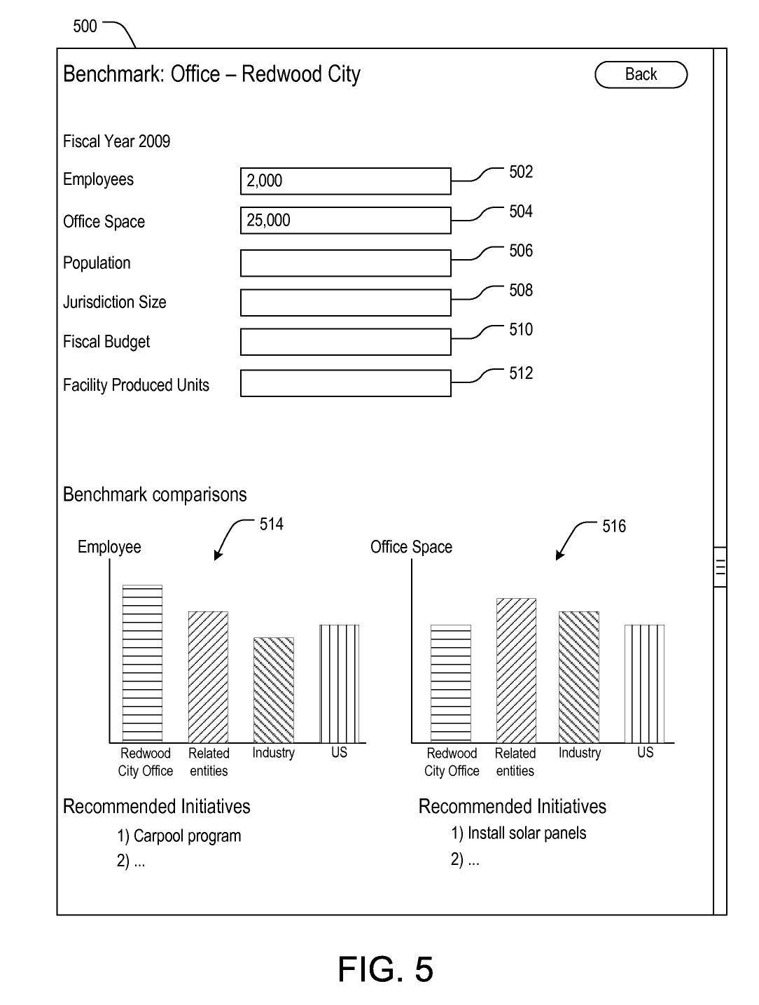

In block 218, server 112 converts the performance metrics of client 1 and the benchmarks into charts. FIG. 5 shows a GUI 500 generated by server 112 for client 1 to see the system generated benchmarks in one or more embodiments of the present disclosure. The top portion provides a list of one or more benchmark types accompanied by editable fields 502 to 512 for their normalization factors. The lower portion provides one or more charts for the benchmark types, where only charts 514 and 516 are visible without scrolling further down. Each benchmark type includes one or more benchmarks generated from their respective demographic filters. Client 1 may also plug in values for its normalization factors and see how the change impacts the charts. Referring back to FIG. 2, block 218 may be followed by block 220.

In block 220, sever 112 transmits the one or more charts to client 1. Block 220 may be followed by block 222.

In block 222, server 112 selects one or more initiatives to reduce environmental impact when any of the client's performance metrics is worse than its benchmark. An initiative may be a single activity or project having a definable cost and energy/emission reduction per year. The emission management software may select the one or more initiatives using predefined rules based on the benchmark type and the difference between client l′s performance metrics and the benchmark. Block 222 may be followed by block 224.

In block 224, server 112 transmits the recommended initiatives to client 1. FIG. 5 shows the recommended initiatives below the corresponding benchmark charts. Referring back to FIG. 2, block 224 may be followed by block 226.

In block 226, server 112 sends an alert to lower organization units of client 1 when any of the client's performance metrics is worse than its benchmark. This action will cause responsible persons in the subordinate organization units to take action to reduce their environmental impact.

Various other adaptations and combinations of features of the embodiments disclosed are within the scope of the invention. Numerous embodiments are encompassed by the following claims.

1. A method for generating benchmarks for an entity, comprising:
receiving a transmission of demographic data and resource consumption data of the entity;
processing, using a programmed processor, the resource consumption data of the entity to derive a measure of environmental impact by the entity;
receiving a transmission of demographic data and resource consumption data of other entities external to the entity;
processing, using the programmed processor, the resource consumption data of the other entities to derive measures of environmental impact by the other entities;
processing, using the programmed processor, the measure of environmental impact by the entity and a normalization factor of the entity to derive a performance metric of the entity, the normalization factor of the entity being from the demographic data of the entity, the performance metric of the entity being the measure of environmental impact by the entity divided by the normalization factor of the entity;
processing, using the programmed processor, the measures of environmental impact by the other entities and normalization factors of the other entities to derive a performance metric of a benchmark, the normalization factors being from the demographic data of the other entities, the performance metric of the benchmark being the measures of environmental impact by the other entities divided by the normalization factors of the other entities;
converting, using the programmed processor, the performance metric of the entity and the performance metric of the benchmark into a chart; and
transmitting the chart to the entity.

2. The method of claim 1, wherein the measure of environmental impact of the entity and the measures of environmental impact of the other entities comprise CO2e emissions, wastewater productions, or resource consumptions.

3. The method of claim 1, further comprising:
in response to the performance metric of the entity and the performance metric of the benchmark, selecting, using the programmed processor, one or more recommended initiatives for reducing environmental impact; and
transmitting the one or more recommended initiatives to the entity.

4. The method of claim 3, wherein the one or more recommended initiatives are selected based on performance metric type.

5. The method of claim 1, further comprising:
in response to the performance metric of the entity and the performance metric of the benchmark, transmitting, using the programmed processor, an alert to the entity's organizational units to reduce their environmental impact.

6. The method of claim 1, wherein the entity comprises organizational units, the method further comprising:
receiving a transmission of a selection of an other normalization factor and a demographic filter;
selecting, using the programmed processor, one or more of the organizational units based on the demographic filter;
processing, using the programmed processor, a measure of environmental impact by an organizational unit and an other normalization factor of the organization unit to derive a an other performance metric of the organizational unit;
processing, using the programmed processor, measures of environmental impact by the one or more selected organizational units and other normalization factors of the one or more selected organizational units to derive an other performance metric of an other benchmark;
converting, using the programmed processor, the other performance metric of the organizational unit and the other performance metric of the other benchmark into an other chart; and
transmitting the other chart to the entity.

7. The method of claim 7, wherein the demographic filter is selected from employee count, office space area, revenue, production hours, produced units, population, jurisdiction size, fiscal budget, industry, geography, and entity relationships.

8. The method of claim 1, further comprising:
selecting, using the programmed processor, one or more of the other entities based on similarities in the demographic data of the entity and the demographic data of the other entities;
processing, using the programmed processor, measures of environmental impact by the one or more selected entities and normalization factors of the one or more selected entities to derive a performance metric of an other benchmark; and
including the other benchmark in the chart.

9. A non-transitory computer-readable storage medium encoded with executable instructions for execution by a processor to generate benchmarks for an entity, the instructions comprising:
receiving a transmission of demographic data and resource consumption data of the entity;
processing, using a programmed processor, the resource consumption data of the entity to derive a measure of environmental impact by the entity;
receiving a transmission of demographic data and resource consumption data of other entities external to the entity;
processing, using the programmed processor, the resource consumption data of the other entities to derive measures of environmental impact by the other entities;
processing, using the programmed processor, the measure of environmental impact by the entity and a normalization factor of the entity to derive a performance metric of the entity, the normalization factor of the entity being from the demographic data of the entity, the performance metric of the entity being the measure of environmental impact by the entity divided by the normalization factor of the entity;
processing, using the programmed processor, the measures of environmental impact by the other entities and normalization factors of the other entities to derive a performance metric of a benchmark, the normalization factors being from the demographic data of the other entities, the performance metric of the benchmark being the measures of environmental impact by the other entities divided by the normalization factors of the other entities;
converting, using the programmed processor, the performance metric of the entity and the performance metric of the benchmark into a chart; and
transmitting the chart to the entity.

10. The non-transitory computer-readable storage medium of claim 9, wherein the measure of environmental impact of the entity and the measures of environmental impact of the other entities comprise CO2e emissions, wastewater productions, or resource consumptions.

11. The non-transitory computer-readable storage medium of claim 9, wherein the instructions further comprise:
in response to the performance metric of the entity and the performance metric of the benchmark, selecting, using the programmed processor, one or more recommended initiatives for reducing environmental impact; and
transmitting the one or more recommended initiatives to the entity.

12. The non-transitory computer-readable storage medium of claim 11, wherein the one or more recommended initiatives are selected based on performance metric type.

13. The non-transitory computer-readable storage medium of claim 8, wherein the instructions further comprise:
in response to the performance metric of the entity and the performance metric of the benchmark, transmitting, using the programmed processor, an alert to the entity's organizational units to reduce their environmental impact.

14. The non-transitory computer-readable storage medium of claim 9, wherein the entity comprises organizational units, wherein the instructions further comprise:
receiving a transmission of a selection of an other normalization factor and a demographic filter;
selecting, using the programmed processor, one or more of the organizational units based on the demographic filter;
processing, using the programmed processor, a measure of environmental impact by an organizational unit and an other normalization factor of the organization unit to derive a an other performance metric of the organizational unit;
processing, using the programmed processor, measures of environmental impact by the one or more selected organizational units and other normalization factors of the one or more selected organizational units to derive an other performance metric of an other benchmark;
converting, using the programmed processor, the other performance metric of the organizational unit and the other performance metric of the other benchmark into an other chart; and
transmitting the other chart to the entity.

15. The non-transitory computer-readable storage medium of claim 14, wherein the demographic filter is selected from employee count, office space area, revenue, production hours, produced units, population, jurisdiction size, fiscal budget, industry, geography, and entity relationships.

16. The non-transitory computer-readable storage medium of claim 9, wherein the instructions further comprise:
selecting, using the programmed processor, one or more of the other entities based on similarities in the demographic data of the entity and the demographic data of the other entities;
processing, using the programmed processor, measures of environmental impact by the one or more selected entities and normalization factors of the one or more selected entities to derive a performance metric of an other benchmark; and
including the other benchmark in the chart.
